(19) United States
(12) Patent Application Publication
(10) Pub. No.: US 2026/0200368 A1
(43) Pub. Date: Jul. 16, 2026

(54) CONTROL APPARATUS IN VEHICLE

(71) Applicant: ISUZU MOTORS LIMITED, Yokohama-shi (JP)

(72) Inventors: Daichi MAEGAWA, Fujisawa-shi (JP); Takanobu OGAWA, Fujisawa-shi (JP); Takatada USAMI, Fujisawa-shi (JP)

(21) Appl. No.: 19/421,067

(22) Filed: Dec. 16, 2025

(30) Foreign Application Priority Data
Jan. 15, 2025 (JP) 2025-005718

(51) Int. Cl. B60L 58/40; B60L 50/75

(52) U.S. Cl. CPC B60L 58/40; B60L 50/75; B60L 2240/54

(57) ABSTRACT

A control apparatus can increase the change amount of the SOC of a battery to a predetermined amount during traveling of the vehicle. The control apparatus comprises a processor. When an SOH of at least one target power storage apparatus among the power storage apparatuses is specified during traveling of the vehicle, the processor controls charge and discharge between the fuel cell system, the power storage apparatuses, and the motor by one of control modes including a first control mode, in which power is supplied from the fuel cell system to the motor and the power storage apparatuses, and a second control mode, in which power is supplied from the fuel cell system to the motor and the target power storage apparatus and is not supplied from the fuel cell system to a power storage apparatus other than the target power storage apparatus among the power storage apparatuses.

### CROSS REFERENCE TO RELATED APPLICATIONS

This application is entitled to (or claims) the benefit of Japanese Patent Application No. 2025-005718 filed on Jan. 15, 2025, the disclosure of which including the specification, drawings and abstract is incorporated herein by reference in its entirety.

### TECHNICAL FIELD

The present disclosure relates to a control apparatus in a vehicle.

### BACKGROUND ART

A fuel cell electric vehicle (FCEV) including the following is known: a fuel cell system (FCS) that generates power using hydrogen; a plurality of power storage apparatuses; and a motor that operates using the power from the fuel cell system and the plurality of power storage apparatuses. In the following description, the power storage apparatus may be referred to as a battery.

For a charge and discharge control apparatus that controls charging and discharging between a plurality of batteries, the FCS, and the motor in such an FCEV, for example, PTL 1 discloses the following method. A method for estimating the health status of a secondary battery in a system using both a fuel cell and a secondary battery, the method including: measuring open circuit voltages by charging the secondary battery to different target charging rates after two uses before and after a standby time of the system; calculating open circuit voltage charging rates based on the measured open circuit voltages; obtaining an input/output current integrated value between the two open circuit voltage measurements; calculating a current integrated charging rate based on the input/output current integrated value; and estimating the health status (SOH) of the secondary battery by a predetermined expression using the difference between the two open circuit voltage charging rates as ASOCv and the current integrated charging rate as ASOCi.

### CITATION LIST

### Patent Literature

PTL 1
Japanese Patent Application Laid-Open No. 2017-143026

### SUMMARY OF INVENTION

### Technical Problem

In the FCEV as described above, it is preferable that the deterioration states of the FCS and the battery progress evenly. Therefore, it is necessary to measure the deterioration state of the battery with high accuracy, for example. In the following description, the deterioration state of a battery may be referred to as SOH (state of health) or a health status. In addition, the charging rate of a battery may be referred to as a stage of charge (SOC) or a remaining capacity.

As a method for measuring the SOH (health status), there is a method for specifying the SOH of a battery from the total output when the SOC (remaining capacity) of the battery transitions from a high state to a low state. In this method for measuring the SOH, the larger the change amount (ASOC) of the SOC is, the higher the measurement accuracy of the SOH is. Therefore, in order to increase the measurement accuracy of the SOH, it is necessary to control the charge and discharge between the plurality of batteries, the FCS, and the motor in such a way that the change amount of the SOC of the battery becomes equal to or more than a predetermined amount. Hereinafter, the change amount (ASOC) may be referred to as a difference.

On the other hand, the charge and discharge control between the plurality of batteries, the FCS, and the motor during traveling of a vehicle is restricted by a requested output of the motor, a power that can be output by the FCS, or the like, and thus there is a problem that it is difficult to increase the change amount of the SOC of a predetermined battery to the predetermined amount or more at an early stage during traveling of the vehicle. As a result, it is difficult to specify the SOH of the predetermined battery with high accuracy in a timely manner, and thus it is difficult to balance the deterioration between the FCS and the battery.

In other words, in order to balance the deterioration between the FCS and the battery, it is required to increase the change amount of the SOC of the predetermined battery to the predetermined amount or more at an early stage during traveling of the vehicle.

An object of the present disclosure is to provide a control apparatus in a vehicle (herein also referred to as “in-vehicle control apparatus”) capable of increasing the change amount of the SOC of a battery to a predetermined amount or more at a relatively early stage during traveling of the vehicle.

### Solution to Problem

In order to achieve the above object, the in-vehicle control apparatus in the present disclosure comprising a processor, the vehicle including a fuel cell system that generates power using hydrogen, a plurality of power storage apparatuses; a motor that operates by power of the fuel cell system and the plurality of power storage apparatuses, the processor, wherein
when specifying an SOH of at least one target power storage apparatus among the plurality of power storage apparatuses is performed during traveling of the vehicle,
the processor controls charge and discharge between the fuel cell system, the plurality of power storage apparatuses, and the motor by one of a plurality of control modes including a first control mode and a second control mode, the first control mode being a mode in which power is supplied from the fuel cell system to the motor and the plurality of power storage apparatuses, the second control mode being a mode in which power is supplied from the fuel cell system to the motor and the at least one target power storage apparatus and is not supplied from the fuel cell system to a power storage apparatus that is other than the at least one target power storage apparatus among the plurality of power storage apparatuses.

### Advantageous Effects of Invention

According to the present disclosure, the change amount of the SOC of the battery can be increased to the predetermined amount or more at a relatively early stage during traveling of the vehicle.

### BRIEF DESCRIPTION OF DRAWINGS

FIG. 1 schematically illustrates a fuel cell electric vehicle on which an in-vehicle control apparatus according to an embodiment of the present disclosure is mounted;

FIG. 2 illustrates a method for calculating the SOC and the like of a battery module according to the present embodiment;

FIG. 3 is a functional block diagram schematically illustrating functions of a control system (VCU) according to the present embodiment;

FIG. 4A illustrates control I when the FCS has spare capacity according to the present embodiment;

FIG. 4B illustrates control I when the FCS does not have spare capacity according to the present embodiment;

FIG. 5A illustrates control II (during measuring of OCV) according to the present embodiment;

FIG. 5B illustrates control III (during discharging) according to the present embodiment;

FIG. 5C illustrates normal control according to the present embodiment;

FIG. 6A illustrates normal control during traveling (FCS has spare capacity) according to the present embodiment;

FIG. 6B illustrates normal control during traveling (FCS has no spare capacity) according to the present embodiment;

FIG. 6C illustrates normal control during regeneration according to the present embodiment;

FIG. 6D illustrates normal control during stoppage (SOC has spare capacity) according to the present embodiment;

FIG. 6E illustrates normal control during stoppage (SOC has no spare capacity) according to the present embodiment;

FIG. 7A illustrates control I (during charging of pack A) during traveling (FCS has spare capacity) according to the present embodiment;

FIG. 7B illustrates control I (during charging of pack A) during traveling (FCS has no spare capacity) according to the present embodiment;

FIG. 7C illustrates control I (during charging of pack A) during regeneration according to the present embodiment;

FIG. 7D illustrates control I (during charging of pack A) during regeneration in each of stoppage (FCS has spare capacity) and stoppage (FCS has no spare capacity) according to the present embodiment;

FIG. 8A illustrates control II (during measuring of OCV) during traveling (FCS has spare capacity) according to the present embodiment;

FIG. 8B illustrates control II (during measuring of OCV) during traveling (FCS has no spare capacity) according to the present embodiment;

FIG. 8C illustrates control II (during measuring of OCV) during regeneration according to the present embodiment;

FIG. 8D illustrates control II (during measuring of OCV) during stoppage (FCS has spare capacity) according to the present embodiment;

FIG. 8E illustrates control II (during measuring of OCV) during stoppage (FCS has no spare capacity) according to the present embodiment;

FIG. 9A illustrates control III (during discharging of pack A) in each of traveling (FCS has spare capacity) and traveling (FCS has no spare capacity) according to the present embodiment;

FIG. 9B illustrates control III (during discharging of pack A) during regeneration according to the present embodiment;

FIG. 9C illustrates control III (during discharging of pack A) during regeneration in each of stoppage (FCS has spare capacity) and stoppage (FCS has no spare capacity) according to the present embodiment;

FIG. 10 illustrates modules connected in parallel in pack according to the present embodiment;

FIG. 11 illustrates modules connected in series in pack according to the present embodiment;

FIG. 12A illustrates two modules electrically connected according to the present embodiment;

FIG. 12B illustrates one module that is electrically disconnected and the other module that is electrically connected according to the present embodiment;

FIG. 12C illustrates one module that is electrically connected and the other module that is electrically disconnected according to the present embodiment;

FIG. 13 is a flowchart illustrating an example of the overall operation of the control system (VCU) according to the present embodiment;

FIG. 14 is a flowchart illustrating an example of the operation of control I (during charging) of the control system (VCU) according to the present embodiment;

FIG. 15 is a flowchart illustrating an example of the operation of control II (during measuring of OCV) of the control system (VCU) according to the present embodiment;

FIG. 16 is a flowchart illustrating an example of the operation of control III (during discharging) of the control system (VCU) according to the present embodiment; and

FIG. 17 is a flowchart illustrating an example of the operation of the control system (VCU) during normal control according to the present embodiment.

### DESCRIPTION OF EMBODIMENTS

Hereinafter, an embodiment of the present disclosure will be described with reference to the drawings.

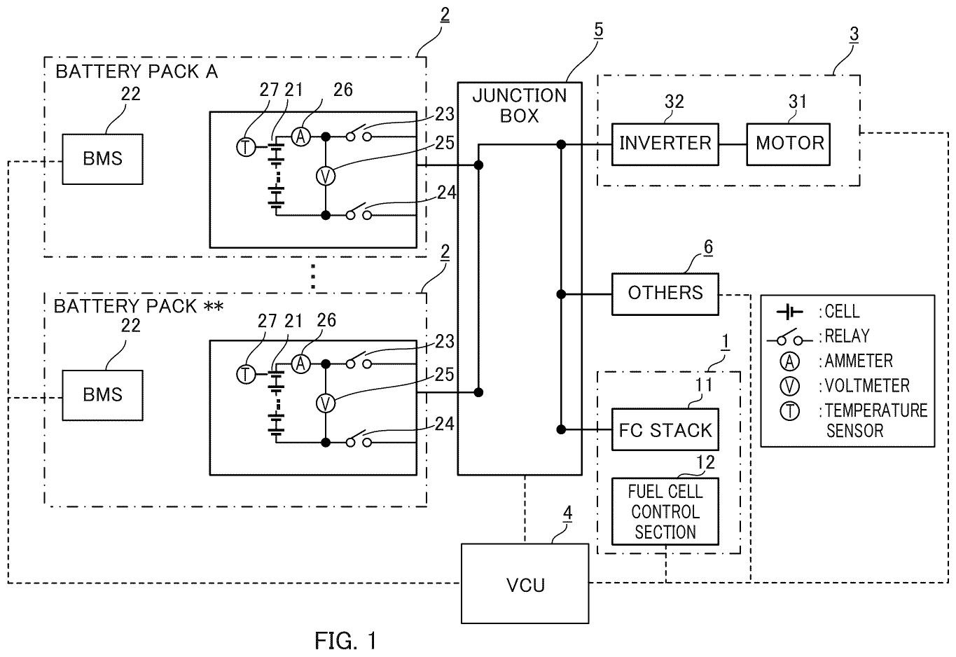

FIG. 1 schematically illustrates a fuel cell electric vehicle on which an in-vehicle control apparatus according to an embodiment of the present disclosure is mounted.

As illustrated in FIG. 1, the fuel cell electric vehicle (FCEV) includes fuel cell system 1 (FCS), a plurality of batteries, electric platform system 3 (electric PF system), control system 4 (corresponding to the “control apparatus” of the present disclosure), and junction box 5.

Fuel cell system 1 (FCS) includes fuel cell stack 11 and fuel cell control section 12 (fuel cell stack electronic control unit: FCS ECU). Hydrogen and oxygen are supplied to fuel cell stack 11. Fuel cell control section 12 controls the pressure and the amount of each of hydrogen and oxygen supplied to fuel cell stack 11. Fuel cell stack 11 supplies motor 31 with electricity generated in a process of converting hydrogen and oxygen into water. Fuel cell control section 12 may estimate a state of health (SOH) indicating a deterioration state (health status) of fuel cell stack 11, and may transmit the estimated SOH to control system 4. For example, by comparing the SOH of fuel cell stack 11 with the SOH of the battery (pack or module), it is possible to balance the deterioration between fuel cell stack 11 and the battery. In the following description, the deterioration of fuel cell stack 11 may be referred to as the deterioration of the FCS, and the SOH of fuel cell stack 11 may be referred to as the SOH of the FCS.

Control system 4 according to the embodiment of the present disclosure is a system that controls the charge and discharge between the three parts, namely fuel cell system 1, the plurality of batteries, and electric PF system 3, based on a predetermined condition during traveling of the vehicle. In this manner, control system 4 according to the embodiment of the present disclosure can provide an effect that allows, by promoting the charging of one of the plurality of batteries, to increase the SOC of the target battery at a relatively early stage during traveling of the vehicle to a predetermined amount or more.

Plurality of battery packs 2 are illustrated in FIG. 1. Battery pack 2 includes one or plurality of battery modules 21 and battery management system (BMS) 22. Battery module 21 is configured by combining a plurality of cells. Battery pack 2 illustrated in FIG. 1 includes one or plurality of battery modules 21, but only one battery module 21 is illustrated in FIG. 1.

In the present embodiment, the charging of a target battery pack 2 among plurality of battery packs 2 is promoted, thereby increasing the SOC of the target battery module 21 at a relatively early stage during traveling of the vehicle to the predetermined amount or more. In the present embodiment, a mode of measuring the SOH for each battery pack 2 (pack) will be described even when each pack includes plurality of battery modules 21.

Therefore, battery pack 2 corresponds to the “battery” in the present disclosure. Alternatively, when battery pack 2 includes plurality of battery modules 21 (modules), and each of the plurality of modules is selectively used (charged and discharged) to measure the SOH for each module, each of the plurality of modules corresponds to the “battery” in the present disclosure. In the present embodiment, first, a case where battery pack 2 (pack) corresponds to the “battery” in the present disclosure will be described. After the description, a case where each battery module 21 (modules) corresponds to the “battery” in the present disclosure will be described.

As illustrated in FIG. 1, battery pack 2 further includes relays 23 and 24, voltmeter 25, ammeter 26, and temperature sensor 27. One of the terminals of relay 23 is connected to the positive terminal of battery module 21. The other terminal of relay 23 is connected to junction box 5 via a high-voltage line. One of the terminals of relay 24 is connected to the negative terminal of battery module 21. The other terminal of relay 24 is connected to junction box 5 via a high-voltage line. Voltmeter 25 measures the voltage of battery module 21 and outputs the measured result to BMS 22. Ammeter 26 measures the current of battery 2 and outputs the measured result to BMS 22. Temperature sensor 27 measures the temperature of battery module 21 (temperature of the cell) and outputs the measured result to BMS 22.

BMS 22 is an electronic control circuit that monitors and controls the charge and discharge of battery module 21. For example, when the voltage, the current, and the temperature of battery module 21 exceed defined ranges based on the measurement results of the voltage, the current, and the temperature of battery module 21, BMS 22 performs off control of relays 23 and 24 to electrically disconnect an external circuit (for example, junction box 5) and power output terminals (the positive terminal and the negative terminal described above) from each other. In this manner, overcharging, overdischarging, overcurrent, and the like of battery module 21 are prevented. When BMS 22 performs the off control of relays 23 and 24, the open circuit voltage (OCV) of battery module 21 is measured by voltmeter 25.

BMS 22 calculates the SOC of battery module 21 based on the open circuit voltage (OCV) of battery module 21 and the temperature of battery module 21. BMS 22 transmits, to control system 4, SOC calculation information indicating that the SOC is calculated. Next, the calculation of the full charge capacity (FCC) of battery module 21 and

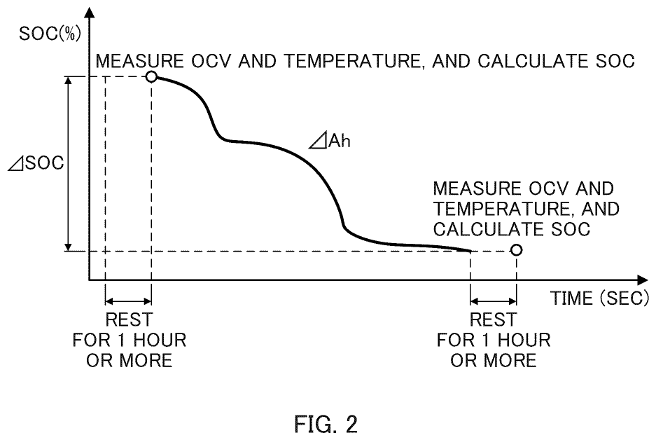

the specifying of the SOH of battery module 21 will be described with reference to FIG. 2. FIG. 2 illustrates a method for calculating the SOC and the like of the battery module according to the present embodiment. The horizontal axis of FIG. 2 indicates time (seconds), and the vertical axis indicates SOC (%). In FIG. 2, a difference between a high state (for example, 80%) of the SOC of battery module 21 and a low state (for example, 20%) of the SOC is represented by “ASOC”. In addition, an integrated amount of the current discharged from battery module 21 until the SOC of battery module 21 changes from the high state (80%) to the low state (20%) is represented by “ΔAh”. Voltmeter 25 measures the open circuit voltage (OCV) of battery module 21 after the SOC of battery module 21 is increased to 80% and battery module 21 is further rested for 1 hour or more. Temperature sensor 27 also measures the temperature of battery module 21. Ammeter 26 measures the open circuit voltage (OCV) of battery module 21 after the SOC of battery module 21 is decreased to 20% and battery module 21 is further rested for 1 hour or more. Temperature sensor 27 also measures the temperature of battery module 21. Ammeter 26 also measures the integrated amount (ΔAh) of the current discharged from battery module 21 until the SOC of battery module 21 changes from the high state (80%) to the low state (20%).

The larger the difference (ASOC) between the high state of the SOC of battery module 21 and the low state of the SOC of battery module 21 is, the more accurately the SOH can be specified. However, in the present embodiment, the high state of the SOC is set to 80%, and the low state of the SOC is set to 20% for the following reasons. The reason why the high state of the SOC is set to 80% is that, when the SOC exceeds 80%, the charging time is prolonged due to battery protection, and thus 80% is appropriate as an upper limit value of the SOC that reaches the target SOC in a short time. In addition, the reason why the low state of the SOC is set to 20% is that, when the SOC is 20% or less, the voltage rapidly decreases and the output decreases, and thus 20% is appropriate as a lower limit value of the SOC that does not hinder traveling.

BMS 22 calculates the current FCC (full charge capacity) from Equation 1 based on the difference (ASOC) and the integrated amount (ΔAh) of the current.

$$FCC = Δ Ah * 100 / Δ SOC \qquad ( 1 )$$

Further, BMS 22 specifies the SOH of battery module 21 from Equation 2 based on the current FCC and the initial FCC.

$$SOH = FCC / FCC ( initial ) * 100 \qquad ( 2 )$$

BMS 22 transmits, to control system 4, SOH specification information indicating that the SOH is specified.

Electric PF system 3 includes motor 31 and inverter 32. Inverter 32 converts direct current (DC) supplied from each of FCS 1 and plurality of battery modules 21 to motor 31 into alternating current (AC).

Motor 31 is a motor for driving the vehicle. The output of motor 31 is controlled by control system 4. VCU 4 controls the rotation speed of motor 31 in such a way that motor 31 outputs a torque in response to a request (accelerator pedal opening amount) of the driver. In the following description, the torque in response to the request of the driver may be referred to as a “requested output of the motor”.

For example, when the vehicle is braked, regenerative power is generated by motor 31. In the following description, the generation of the regenerative power in motor 31 is referred to as “motor regeneration” or simply “regeneration”, and the time when or while the regenerative power is generated by motor 31 is referred to as “during regeneration operation” or simply “during regeneration”. In addition, information indicating the regeneration operation is referred to as “regeneration operation time information”.

Control system 4 is a vehicle control unit (VCU) that controls each of fuel cell system 1, plurality of battery modules 21, electric PF system 3, junction box 5 (J/B), and one or a plurality of components. In FIG. 1, one or a plurality of components are indicated by “other components 6”. For example, control system 4 (VCU) controls the amount of charge and discharge of battery module 21 from the relationship between the requested output of motor 31 and the output of FCS 1. Control system 4 also controls, for example, the regenerative power regenerated from motor 31 when the vehicle is braked, according to the SOC of battery module 21. Control system 4 also controls the power generation amount of FCS 1 according to the requested output of motor 31. Control system 4 also controls on and off of FCS 1 according to an environmental condition, a preparation state, and a traveling state of the vehicle. Control system 4 also controls on and off of a relay circuit in junction box 5 under a predetermined condition.

Junction box 5 is disposed between FCS 1, the plurality of battery modules 21, electric PF system 3 and other components 6. Junction box 5 includes a relay circuit (not illustrated) and a battery management system (not illustrated) that controls on and off of the relay circuit. The battery management system receives control information from control system 4 and controls on and off of the relay circuit-control system 4 is a system that controls the charge and discharge between the three parts, namely the plurality of battery modules 21, FCS 1, and motor 31.

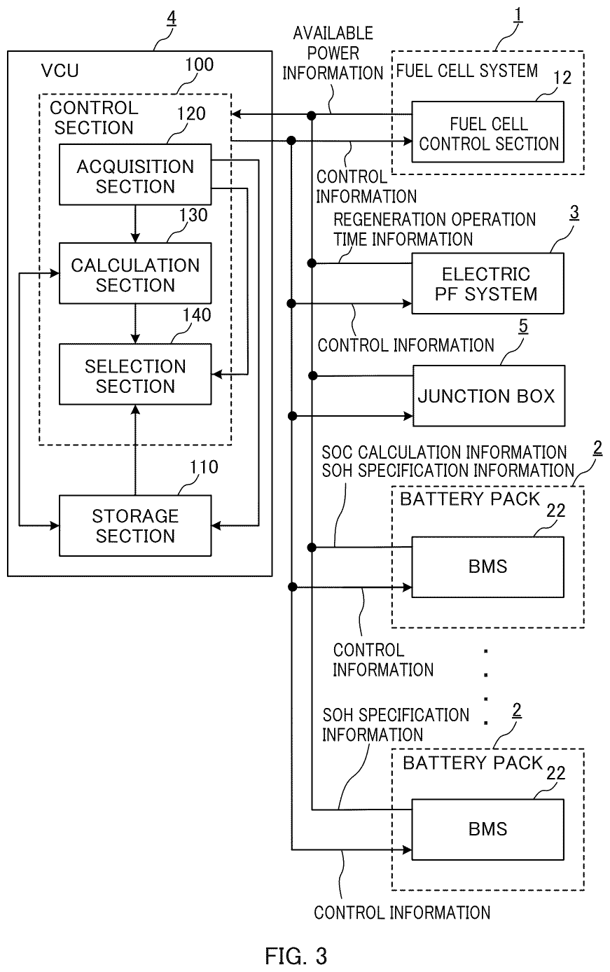

Control system 4 (VCU) includes control section 100 and storage section 110 (see FIG. 3). Storage section 110 is a read only memory (ROM) that stores a program of a computer that implements control system 4 and/or a random access memory (RAM) that is a work area of control section 100. In addition, interfaces, such as an A-D converter, a D-A converter, an I/O port, and a CAN, are also provided. The ROM may be a storage apparatus such as a hard disk drive (HDD) or a solid state drive (SSD) that stores an operating system (OS), an application program, and various types of information referred to during execution of the application program.

Control section 100 is a processor such as a central processing unit (CPU) and/or a graphics processing unit (GPU) of control system 4 (VCU), and functions as described below by executing a program stored in storage section 110. Control section 100 is not limited to a case where control section 100 is configured by a single apparatus. Control section 100 may be implemented by, for example, a plurality of processors, a memory, and the like. In this case, each section in control section 100 is implemented by executing a program by at least one of the plurality of different processors.

Storage section 110 stores a normal program, a program I, a program II, and a program III as programs for controlling the charge and discharge between the three parts, namely plurality of battery modules 21, FCS 1, and motor 31. In the following description, the normal program may be referred to as “normal control”, the program I may be referred to as “control I”, the control program II may be referred to as “control II”, and the program III may be referred to as “control III”.

Control system 4 (VCU) selects battery module 21 (for which a SOH (health status) is to be specified) from the plurality of battery modules 21 in a predetermined order every predetermined period (for example, one month). The predetermined period may be adjustable by the user or may be adjustable according to the SOH of each battery module 21.

As a method for specifying the SOH (health status) of battery module 21, there is a method for specifying the SOH of the battery from the total output when the SOC (remaining capacity) of battery module 21 transitions from a high state to a low state. In this method for specifying the SOH, the larger the change amount (ASOC) of the SOC is, the higher the accuracy for specifying the SOH is. Therefore, in the present embodiment, in order to increase the change amount (ASOC) of the SOC to a predetermined amount or more, the high state of the SOC of battery module 21 is set to a state in which the SOC of battery module 21 is “80%”, and “80%” is set as a first threshold value of the SOC of battery module 21. In addition, the low state of the SOC of battery module 21 is set to a state in which the SOC of battery module 21 is “20%”, and “20%” is set as a second threshold value of the SOC of battery module 21.

In the present embodiment, fluctuation control of the SOC is performed in such a way that the SOC of battery module 21 is increased to the first threshold value (80%) during traveling of the vehicle, and then the SOC is decreased to the second threshold value (20%). The change amount of the SOC from the first threshold value to the second threshold value is referred to as a “predetermined amount”. In order to perform the fluctuation control of the SOC as quickly as possible, control system 4 (VCU) according to the present embodiment controls the charge and discharge between the three parts, namely plurality of battery modules 21, FCS 1, and motor 31, in such a way that the change amount of the SOC of battery module 21 is increased to the predetermined amount or more at a relatively early stage during traveling of the vehicle.

FIG. 3 is a block diagram illustrating functions of control section 100 in VCU 4 according to the present embodiment. Control section 100 functions as acquisition section 120, calculation section 130, and selection section 140.

Acquisition section 120 acquires requested output information related to the requested output of motor 31. Acquisition section 120 acquires available power information related to the power that can be output by FCS 1 from fuel cell control section 12.

In addition, acquisition section 120 acquires regeneration operation time information indicating a time when the regenerative power is generated by motor 31.

Calculation section 130 calculates the spare capacity of FCS 1 based on the requested output information and the available power information.

Control section 100 controls the charge and discharge between the three parts, namely plurality of battery modules 21, FCS 1, and motor 31, based on a predetermined condition in such a way that the change amount of the SOC of battery module 21 is increased to the predetermined amount or more at a relatively early stage during traveling of the vehicle.

During traveling of the vehicle, selection section 140 selects a program corresponding to the predetermined condition from the normal program (normal control), the program I (control I), the program II (control II), and the program III (control III).

In the present embodiment, battery pack 2 includes one battery module 21 as illustrated in FIG. 1, and therefore, specifying the SOH of battery module 21 corresponds to specifying the SOH of battery pack 2. In the following description, battery pack 2 may be referred to as a “pack”, and battery module 21 may be referred to as a “module”. In addition, pack 2 and module 21 may be collectively referred to as a “battery”.

### <Method for Specifying SOH of Battery>

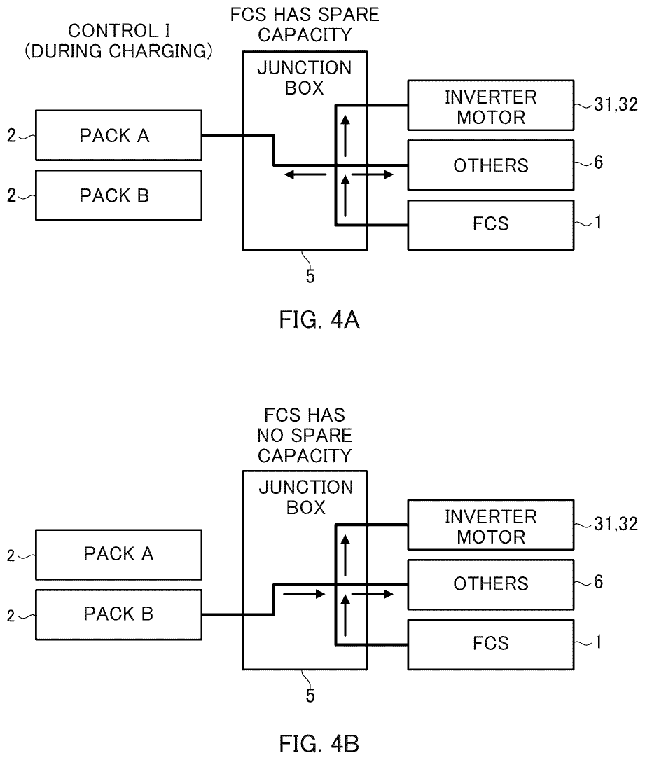

Next, the method for specifying the SOH of the battery will be described with reference to FIGS. 4A and 4B. FIG. 4A illustrates control I when the FCS has spare capacity. FIG. 4B illustrates control I when the FCS does not have spare capacity. The spare capacity of FCS 1 is calculated by calculation section 130. Control section 100 controls the charge and discharge between the three parts, namely packs A and B, FCS 1, and motor 31, based on the calculated spare capacity of FCS 1 (charge and discharge control). FIG. 4A and FIG. 4B illustrate packs A and B and arrows indicating the directions of power supply. Hereinafter, the case of specifying the SOH of pack A will be described. That is, pack A corresponds to the “target power storage apparatus” of the present disclosure.

First, control section 100 selects pack A whose SOH is to be specified from packs A and B.

Next, when FCS 1 has spare capacity, control section 100 executes the control of charging pack A (FCS has spare capacity). As a result, the power is supplied from FCS 1 to pack A. In addition, the power is supplied from FCS 1 to inverter 32 and motor 31. In addition, the power is supplied from FCS 1 to other components 6. The power is not supplied from FCS 1 to pack B.

When FCS 1 does not have spare capacity, control section 100 executes the control of using only pack B to travel (FCS has no spare capacity). As a result, the power is supplied from FCS 1 to inverter 32 and motor 31. In addition, the power is supplied from FCS 1 to other components 6. The power is supplied from pack B to inverter 32 and motor 31. The power is not supplied from FCS 1 to pack A.

With the above-described charge and discharge control, the SOC of pack A can quickly reach 80% (first threshold value).

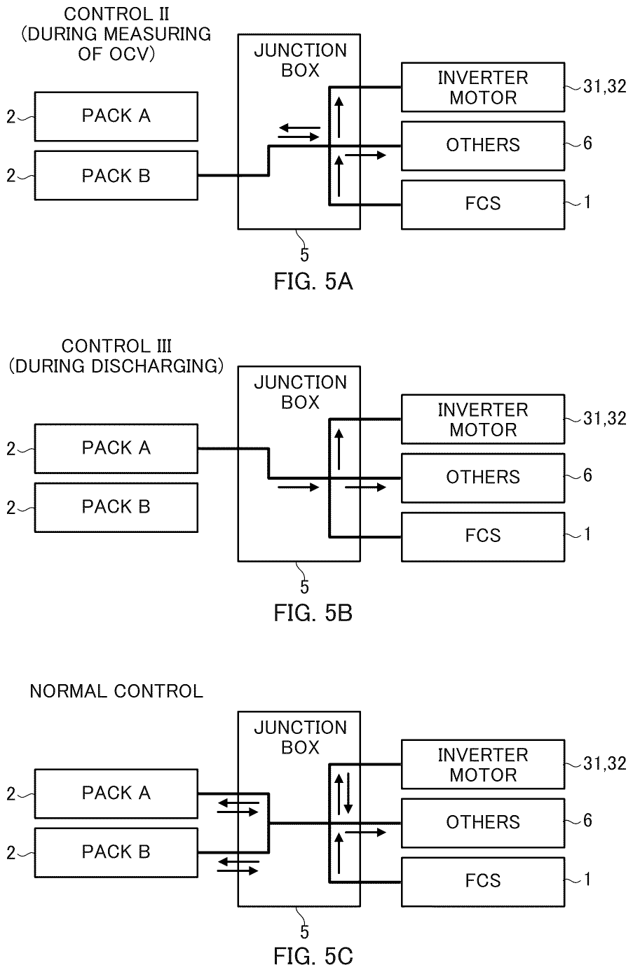

FIG. 5A illustrates control II (during measuring of OCV). FIG. 5B illustrates control III (during discharging). FIG. 5C illustrates normal control. FIGS. 5A, 5B, and 5C illustrate packs A and B and arrows indicating the directions of power supply.

When the SOC of pack A reaches 80% (first threshold value), control section 100 switches from control I to control II.

After one hour from switching from control I to control II, voltmeter 25 measures the open circuit voltage (OCV) of pack A (control II (during measuring of OCV) illustrated in FIG. 5A). Temperature sensor 27 measures the temperature of pack A. The measured OCV of pack A and the temperature of pack A are output to BMS 22.

Next, after measuring the OCV of pack A and the temperature of pack A, control section 100 switches from control II to control III and executes the control of discharging until the SOC of pack A reaches 20% (second threshold value) with control III (control III (during discharging) illustrated in FIG. 5B). As a result, the power is supplied from pack A to inverter 32, motor 31, and the like, and the SOC of pack A decreases.

When the SOC of pack A becomes less than 20% (second threshold value), control section 100 switches from control III to control II. After one hour from switching from control III to control II, voltmeter 25 measures the open circuit voltage (OCV) of pack A. Temperature sensor 27 measures the temperature of pack A. The measured OCV of pack A and the temperature of pack A are output to BMS 22.

Next, BMS 22 calculates the current FCC (full charge capacity) from the integrated amount (ΔAh) of the current when the SOC changes from 80% to 20%, the OCV of pack A, and the temperature of pack A. Further, BMS 22 specifies the SOH from the current FCC and the initial FCC.

Next, control section 100 switches from control II to control I and executes the control of charging pack A with control I. In this manner, the power is supplied from FCS 1 to pack A. As a result, the SOC of pack A can be made equal to the SOC of pack B. After the SOC of pack A and the SOC of pack B become equal, control section 100 returns from control I to the normal control (normal control illustrated in FIG. 5C).

As described above, the specification of the SOH of pack A is completed in a short time and the normal control is returned, and therefore, the control can be switched during the traveling state, and the target SOC can be reached quickly (control I and control III). In addition, since pack A needs to be rested for one hour in order to measure the OCV, the control can be switched to use only pack B, namely the other pack (control II).

As described above, control system 4 according to the present embodiment is a system that controls, during traveling of the vehicle, the charge and discharge between the three parts, namely fuel cell system 1, plurality of packs 2, and electric PF system 3, based on a predetermined condition. The purpose of the above configuration is as follows: by promoting charging of any one (as a target pack 2) of the plurality of packs 2 during traveling of the vehicle, it is possible to increase the SOC of the target pack 2 to a predetermined amount or more at a relatively early stage, and as a result, it becomes possible to specify the SOH of the target pack 2 at any timing.

### <Comparison of Controls (Normal Control)>

Hereinafter, the control for each predetermined condition will be described.

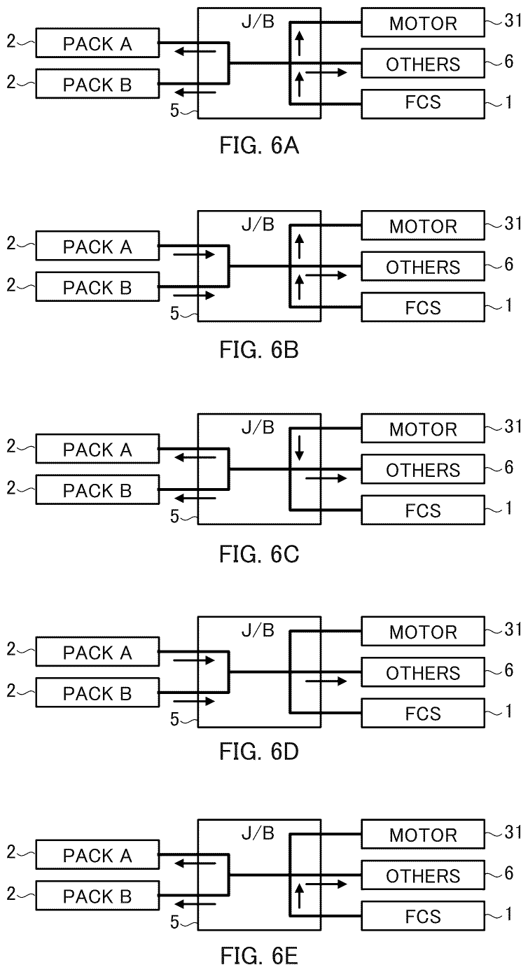

First, the normal control executed by control section 100 for each state of the vehicle will be described with reference to FIGS. 6A to 6E. FIG. 6A illustrates normal control during traveling (FCS has spare capacity). FIG. 6B illustrates normal control during traveling (FCS has no spare capacity). FIG. 6C illustrates normal control during regeneration. FIG. 6D illustrates normal control during stoppage (SOC has spare capacity). FIG. 6E illustrates normal control during stoppage (SOC has no spare capacity). FIGS. 6A to 6E illustrate packs A and B and arrows indicating the directions of power supply. In addition, other components 6 are indicated by “others”. Hereinafter, the case of specifying the SOH of pack A will be described. That is, pack A corresponds to the “target power storage apparatus” of the present disclosure.

As illustrated in FIG. 6A, in the normal control during traveling (FCS has spare capacity), the power is supplied from FCS 1 to pack A, pack B, motor 31, and other components 6.

As illustrated in FIG. 6B, in the normal control during traveling (FCS has no spare capacity), the power is supplied from packs A and B and FCS 1 to motor 31 and other components 6.

As illustrated in FIG. 6C, in the normal control during regeneration, the regenerative power generated by motor 31 is supplied to pack A, pack B, and other components 6.

As illustrated in FIG. 6D, in the normal control during stoppage (SOC has spare capacity), the power is supplied from packs A and B to other components 6.

As illustrated in FIG. 6E, in the normal control during stoppage (SOC has no spare capacity), the power is supplied from FCS 1 to pack A, pack B, and other components 6.

### <Comparison of Controls (Control I During Charging of Pack A)>

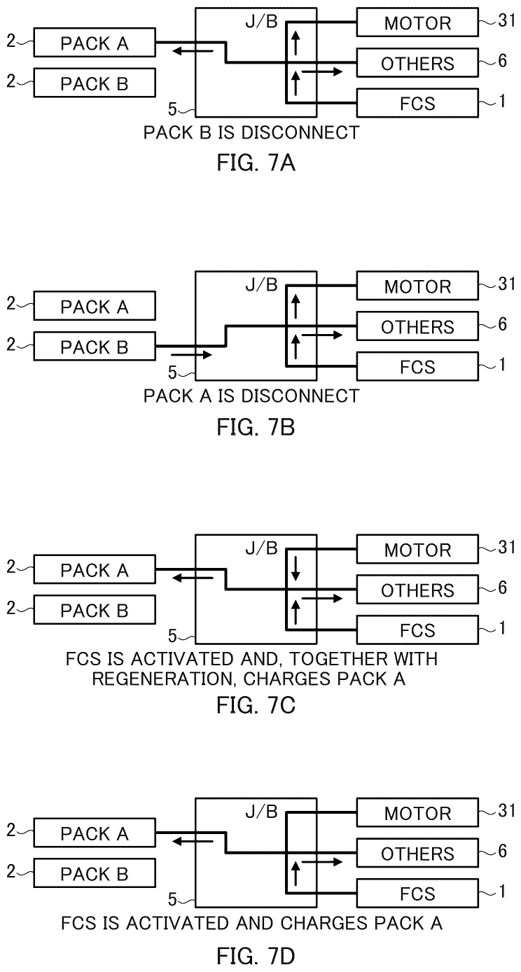

Next, control I (during charging of pack A) executed by control section 100 for each state of the vehicle will be described with reference to FIGS. 7A to 7D. FIG. 7A illustrates control I (during charging of pack A) during traveling (FCS has spare capacity). FIG. 7B illustrates control I (during charging of pack A) during traveling (FCS has no spare capacity). FIG. 7C illustrates control I (during charging of pack A) during regeneration. FIG. 7D illustrates control I (during charging of pack A) in each of stoppage (SOC has spare capacity) and stoppage (SOC has no spare capacity). FIGS. 7A to 7D illustrate packs A and B and arrows indicating the directions of power supply. In addition, other components 6 are indicated by “others”. Hereinafter, the case of specifying the SOH of pack A will be described. That is, pack A corresponds to the “target power storage apparatus” of the present disclosure.

As illustrated in FIG. 7A, in control I (during charging of pack A) during traveling (FCS has spare capacity), the power is supplied from FCS 1 to pack A, motor 31, and other components 6. Pack B is electrically disconnected so that the power is not supplied from FCS 1 to pack B.

As illustrated in FIG. 7B, in control I (during charging of pack A) during traveling (FCS has no spare capacity), the power is supplied from FCS 1 and pack B to motor 31 and other components 6. Pack A is electrically disconnected so that the power is not supplied to motor 31 and the like from pack A.

As illustrated in FIG. 7C, in control I (during charging of pack A) during regeneration, the regenerative power generated by motor 31 is supplied to pack A and other components 6. In addition, the power is supplied from FCS 1 to pack A. The power is not supplied from FCS 1 to pack B. That is, FCS 1 is activated and, together with regeneration, charges pack A with priority.

As illustrated in FIG. 7D, in each of control I (during charging of pack A) during stoppage (SOC has spare capacity) and control I (during charging of pack A) during stoppage (SOC has no spare capacity), the power is supplied from FCS 1 to pack A and other components 6. That is, FCS 1 is activated, and pack A is charged with priority.

### <Comparison of Controls (Control II During Measuring of OCV)>

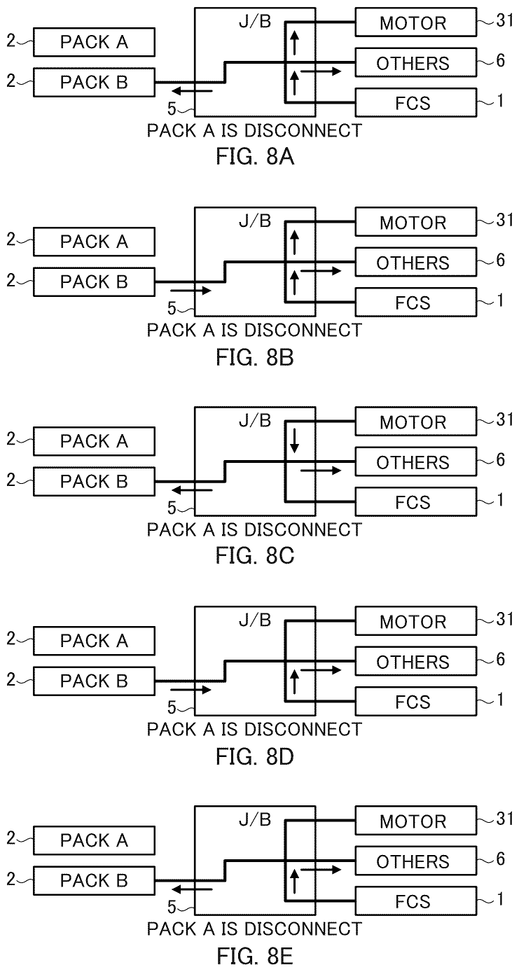

Next, control II (during measuring of OCV) executed by control section 100 for each state of the vehicle will be described with reference to FIGS. 8A to 8E. FIG. 8A illustrates control II (during measuring of OCV) during traveling (FCS has spare capacity). FIG. 8B illustrates control II (during measuring of OCV) during traveling (FCS has no spare capacity). FIG. 8C illustrates control II (during measuring of OCV) during regeneration. FIG. 8D illustrates control II (during measuring of OCV) during stoppage (SOC has spare capacity). FIG. 8E illustrates control II (during measuring of OCV) during stoppage (SOC has no spare capacity). FIGS. 8A to 8E illustrate packs A and B and arrows indicating the directions of power supply. In addition, other components 6 are indicated by “others”. Hereinafter, the case of specifying the SOH of pack A will be described. That is, pack A corresponds to the “target power storage apparatus” of the present disclosure.

As illustrated in FIG. 8A, in control II (during measuring of OCV) during traveling (FCS has spare capacity), the power is supplied from FCS 1 to pack B, motor 31, and other components 6. Pack A is electrically disconnected so that the power is not supplied from FCS 1 to pack A.

As illustrated in FIG. 8B, in control II (during measuring of OCV) during traveling (FCS has no spare capacity), the power is supplied from FCS 1 and pack B to motor 31 and other components 6. Pack A is electrically disconnected so that the power is not supplied to motor 31 and the like from pack A.

As illustrated in FIG. 8C, in control II (during measuring of OCV) during regeneration, the regenerative power generated by motor 31 is supplied to pack B and other components 6. Pack A is electrically disconnected so that the regenerative power generated by motor 31 is not supplied to pack A.

As illustrated in FIG. 8D, in control II (during measuring of OCV) during stoppage (SOC has spare capacity), the power is supplied from FCS 1 and pack B to other components 6. Pack A is electrically disconnected so that the power is not supplied to other components 6 from pack A.

As illustrated in FIG. 8E, in control II (during measuring of OCV) during stoppage (SOC has no spare capacity), the power is supplied from FCS 1 to pack B and other components 6. Pack A is electrically disconnected so that the power is not supplied to other components 6 from pack A.

### <Comparison of Controls (Control III During Discharging of Pack A)>

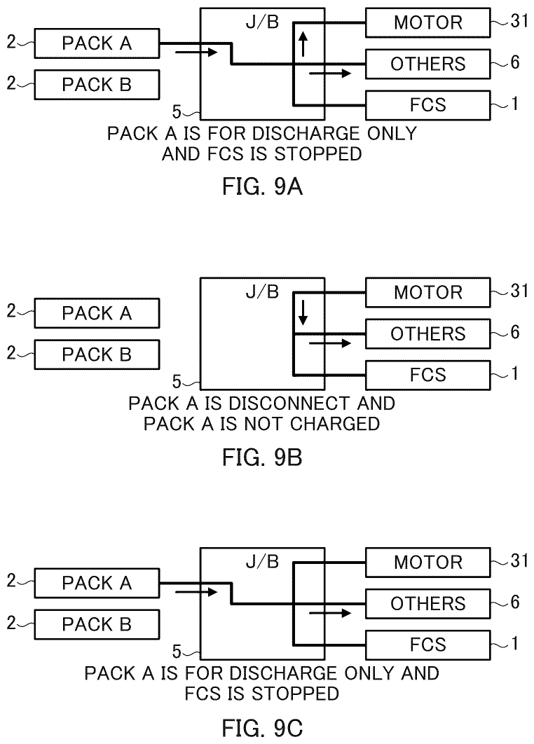

Next, control III (during discharging of pack A) executed by control section 100 for each state of the vehicle will be described with reference to FIGS. 9A to 9C. FIG. 9A illustrates control III (during discharging of pack A) in each of traveling (FCS has spare capacity) and traveling (FCS has no spare capacity). FIG. 9B illustrates control III (during discharging of pack A) during regeneration. FIG. 9C illustrates control III (during discharging of pack A) in each of stoppage (SOC has spare capacity) and stoppage (SOC has no spare capacity). FIGS. 9A to 9C illustrate packs A and B and arrows indicating the directions of power supply. In addition, other components 6 are indicated by “others”. Hereinafter, the case of specifying the SOH of pack A will be described. That is, pack A corresponds to the “target power storage apparatus” of the present disclosure.

As illustrated in FIG. 9A, in each of control III (during discharging of pack A) during traveling (FCS has spare capacity) and control III (during discharging of pack A) during traveling (FCS has no spare capacity), the power is supplied from pack A to motor 31 and other components 6. The FCS 1 is stopped and pack B is electrically disconnected so that the power is not supplied from FCS 1 or pack B to motor 31 and other components 6. That is, pack A is discharged with priority.

As illustrated in FIG. 9B, in control III (during discharging of pack A) during regeneration, the regenerative power generated by motor 31 is supplied to other components 6. Pack A is electrically disconnected so that the regenerative power generated by motor 31 is not supplied to pack A.

As illustrated in FIG. 9C, in each of control III (during discharging of pack A) during stoppage (SOC has spare capacity) and control III (during discharging of pack A) during stoppage (SOC has no spare capacity), the power is supplied from pack A to motor 31 and other components 6. The FCS 1 is stopped and pack B is electrically disconnected so that the power is not supplied from FCS 1 or pack B to motor 31 and other components 6. That is, pack A is discharged with priority.

### <Configuration of Module Connected in Parallel>

Since pack 2 according to the above-described embodiment includes one module 21, the case of specifying the SOH of pack 2 has been described. On the other hand, when pack 2 includes the plurality of modules 21 and each battery module 21 is selectively used (charged and discharged), the SOH of each module 21 needs to be specified.

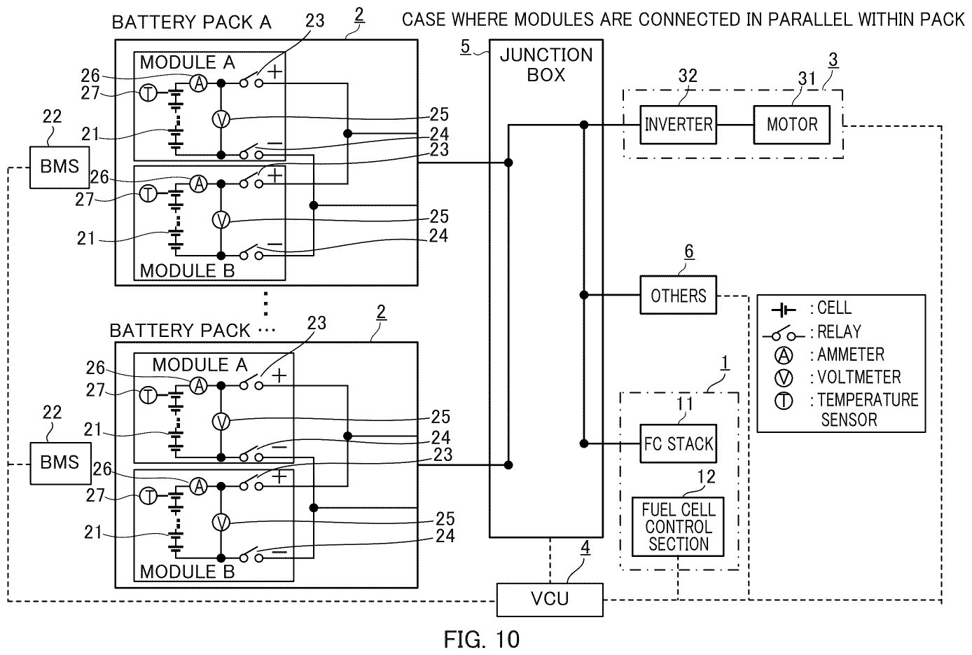

Next, a method in the case of specifying the SOH of module 21 will be described with reference to FIG. 10. FIG. 10 illustrates modules connected in parallel in a pack. FIG. 10 illustrates plurality of packs 2 and modules A and B in each pack 2. In the present method, a configuration different from the above-described embodiment will be described, and the description of the same configuration will be omitted.

Control system 4 (VCU) is a system that controls the charge and discharge between the three parts, namely the plurality of modules 21 (A and B), FCS 1, and motor 31, and transmits control information to the battery management system (not illustrated) and to BMS 22 in junction box 5.

The battery management system receives control information from control system 4 and controls on and off of the relay circuit in junction box 5. Further, BMS 22 receives control information from control system 4 and performs on and off control of relays 23 and 24 in module 21. As a result, module 21 that is the target whose SOH is to be specified is selected, and the SOH of the selected module 21 can be specified. In the present method, selected module 21 corresponds to the “target power storage apparatus” of the present disclosure.

### <Configuration of Series-Connected Modules>

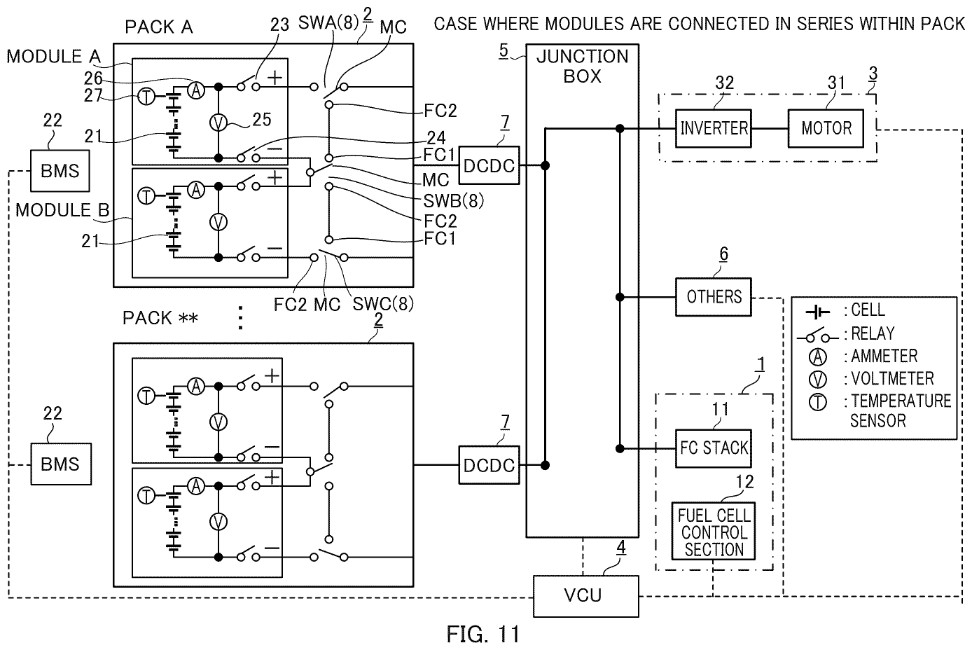

Next, another method in the case of specifying the SOH of module 21 will be described with reference to FIG. 11. FIG. 11 illustrates modules connected in series (series-connected modules) in a pack. FIG. 11 illustrates plurality of packs 2 and modules A and B in pack 2. Hereinafter, in the present method, a configuration different from the above-described embodiment will be described, and the description of the same configuration will be omitted.

Regarding modules A and B connected in series in pack 2 illustrated in FIG. 11, when either module A or B is electrically disconnected, the voltage of pack 2 is decreased. In order to prevent the decrease in the voltage of pack 2, the DC/DC converter 7 (DCDC) is disposed on a high-voltage line between junction box 5 and pack 2.

Pack 2 includes switching circuit 8. Switching circuit 8 is disposed on a high-voltage line between DCDC 7 and pack 2. Switching circuit 8 includes switch SWA, switch SWB, and switch SWC. Each of switches SWA, SWB, and SWC includes one movable contact MC and two fixed contacts FC1 and FC2.

In switch SWA, one end part of movable contact MC is electrically connected to the positive terminal of DCDC 7. With the one end part serving as a fulcrum, the other end part of movable contact MC is configured to be swingable (capable of switching operation) between a state in which the other end part is electrically connected to fixed contact FC1 and is electrically disconnected from fixed contact FC2, and a state in which the other end part is electrically disconnected from fixed contact FC1 and is electrically connected to fixed contact FC2. Fixed contact FC1 is electrically connected to the positive terminal of module A via the relay circuit of module A. Fixed contact FC2 is electrically connected to fixed contact FC1 of switch SWB.

In switch SWB, one end part of movable contact MC is electrically connected to the negative terminal of module A via the relay circuit of module A. The one end part of movable contact MC is also electrically connected to the positive terminal of module B via the relay circuit of module B. With the one end part serving as a fulcrum, the other end part of movable contact MC is configured to be swingable (capable of switching operation) between a state in which the other end part is electrically connected to fixed contact FC1 and is electrically disconnected from fixed contact FC2, and a state in which the other end part is electrically disconnected from fixed contact FC1 and is electrically connected to fixed contact FC2. As described above, fixed contact FC1 is electrically connected to fixed contact FC2 of switch SWA. Fixed contact FC2 is electrically connected to fixed contact FC1 of switch SWC.

In switch SWC, one end part of movable contact MC is electrically connected to the negative terminal of DCDC 7. With the one end part serving as a fulcrum, the other end part of movable contact MC is configured to be swingable (capable of switching operation) between a state in which the other end part is electrically connected to fixed contact FC1 and is electrically disconnected from fixed contact FC2, and a state in which the other end part is electrically disconnected from fixed contact FC1 and is electrically connected to fixed contact FC2. As described above, fixed contact FC1 is electrically connected to fixed contact FC2 of switch SWB. Fixed contact FC2 is electrically connected to the negative terminal of DCDC 7.

The switching operation of movable contact MC of each of switches SWA, SWB, and SWC is controlled by BMS 22.

Control system 4 (VCU) is a system that controls the charge and discharge between the three parts, namely the plurality of modules 21 (A and B), FCS 1, and motor 31, and transmits control information to the battery management system (not illustrated) and to BMS 22 in junction box 5.

The battery management system receives control information from control system 4 and controls on and off of the relay circuit in junction box 5. Further, BMS 22 receives control information from control system 4 and performs on and off control of relays 23 and 24 in module 21. Further, BMS 22 performs switching operation control of movable contact MC of each of switches SWA, SWB, and SWC. As a result, module 21 that is the target of specifying the SOH is selected, and the SOH of the selected module 21 can be specified. In the present method, selected module 21 corresponds to the “target power storage apparatus” of the present disclosure.

### <Specification of SOH of Series-Connected Module>

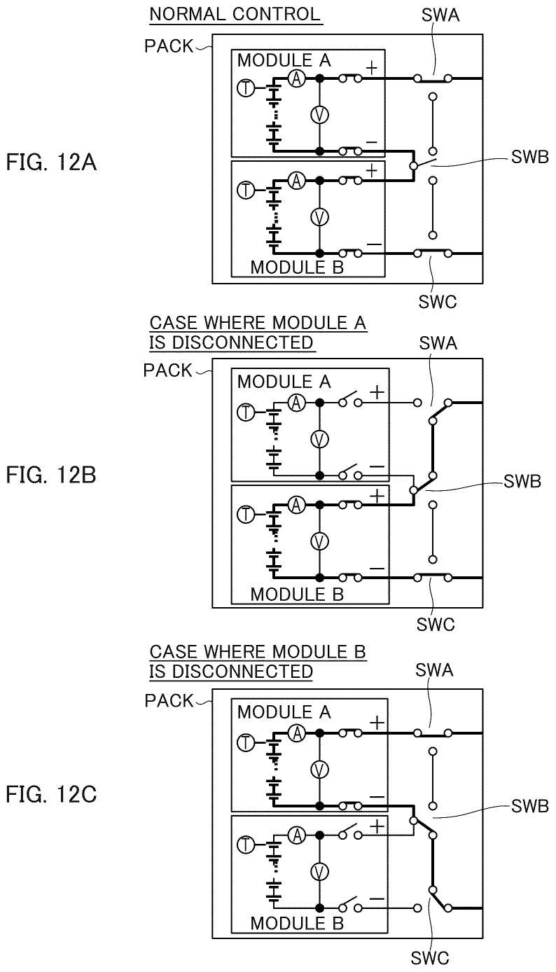

Next, a specific example in the case of specifying the SOH of the series-connected module 21 will be described with reference to FIGS. 12A to 12C. FIG. 12A illustrates two modules that are electrically connected. FIG. 12B illustrates one module that is electrically disconnected and the other module that is electrically connected. FIG. 12C illustrates one module that is electrically connected and the other module that is electrically disconnected. FIGS. 12A to 12C illustrate modules A and B that are connected in series in pack 2 and omit DCDC 7 (see FIG. 11) and junction box 5 (see FIG. 11). Here, the term “electrically connected” means that module A and/or module B is electrically connected to junction box via DCDC 7. In addition, the term “electrically disconnected” means that module A and/or module B is electrically disconnected from junction box 5 via DCDC 7. Module A and/or module B is electrically connected or disconnected by controlling the switching operation of movable contact MC of each of switches SWA, SWB, and SWC by BMS 22.

As illustrated in FIG. 12A, in a normal state, modules A and B are electrically connected. As a result, the power can be supplied from the series-connected modules 21 (A and B) to motor 31 or other components 6.

In the case of specifying the SOH of either module A or B, as illustrated in FIG. 12B, module A is electrically disconnected and module B is electrically connected as necessary. Alternatively, as illustrated in FIG. 12C, module A is electrically connected and module B is electrically disconnected as necessary.

### <Overall Operation of Control System (VCU)>

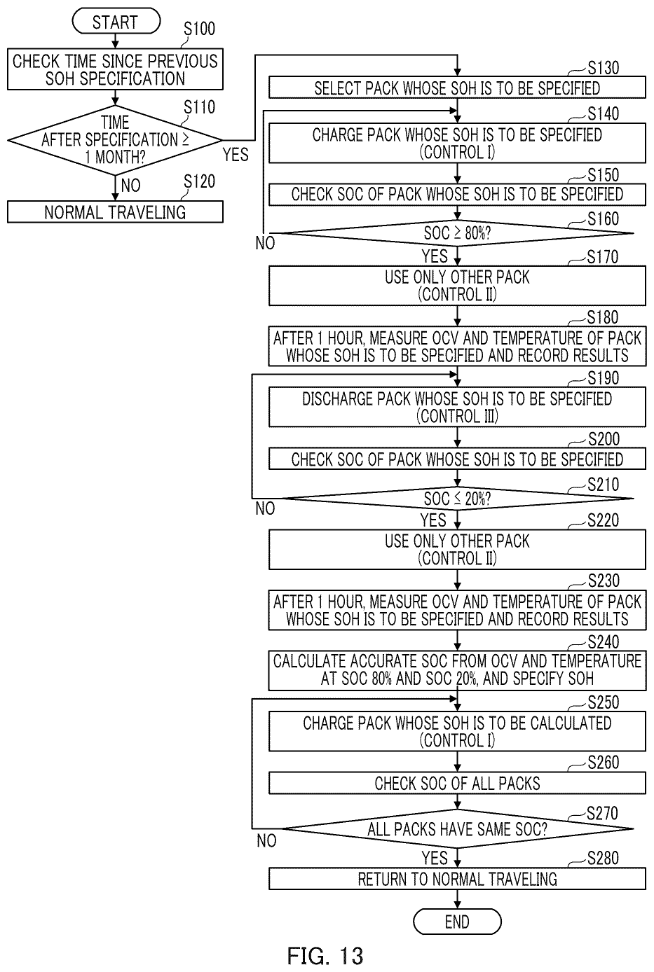

Next, an example of the overall operation of control system 4 (VCU) according to the present embodiment will be described with reference to FIG. 13. FIG. 13 is a flowchart illustrating an example of the operation of the control system (VCU) according to the present embodiment. The flow illustrated in FIG. 13 is started, for example, by turning on a start switch of the vehicle. Here, for convenience, pack 2 whose SOH is to be specified is referred to as pack A, and the other pack is referred to as pack B.

First, in step S100, control section 100 of VCU 4 checks the time from the previous SOH specification.

Next, in step S110, control section 100 determines whether or not the time after the specification is one month or more. When the time after the specification is one month or more (step S110: yes), the processing transitions to step S130. When the time after the specification is not one month or more (step S110: no), the processing transitions to step S120.

In step S120, control section 100 controls the charge and discharge between the three parts, namely fuel cell system 1, plurality of packs 2, and electric PF system 3 so that the vehicle travels normally (normal traveling).

Next, in step S130, control section 100 selects pack A as pack 2 whose SOH is to be specified based on a predetermined order.

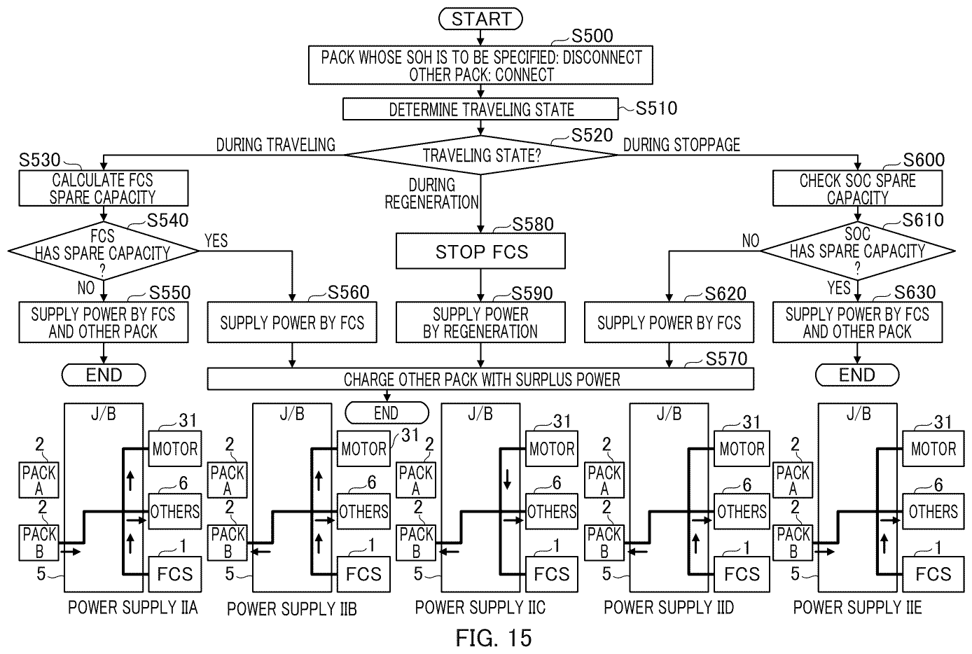

Next, in step S140, control section 100 executes the control of charging pack A whose SOH is to be specified (control I). In control I, the SOC calculation information of pack A is transmitted from BMS 22. Details of control I will be described below with reference to FIG. 15 as the operation of control I (during charging) of the control system (VCU).

Next, in step S150, control section 100 checks the SOC calculation information of pack A whose SOH is to be specified.

Next, in step S160, control section 100 determines whether or not the SOC of pack A is 80% or more. When the SOC of pack A is 80% or more (step S160: yes), the processing transitions to step S170. When the SOC of pack A is not 80% or more (step S160: no), the processing returns to before step S140.

In step S170, control section 100 executes the control of using only the other pack 2 (discharging only pack B) (control II). Details of control II will be described below with reference to FIG. 15 as the operation of control II (during measuring of OCV) of the control system (VCU).

In step S180, after one hour from the determination that the SOC of pack A is 80% or more, control section 100 performs the following control with respect to BMS 22: storing the measurement results of the open circuit voltage (OCV) and the temperature of pack A whose SOH is to be specified in the storage section (not illustrated) in BMS 22.

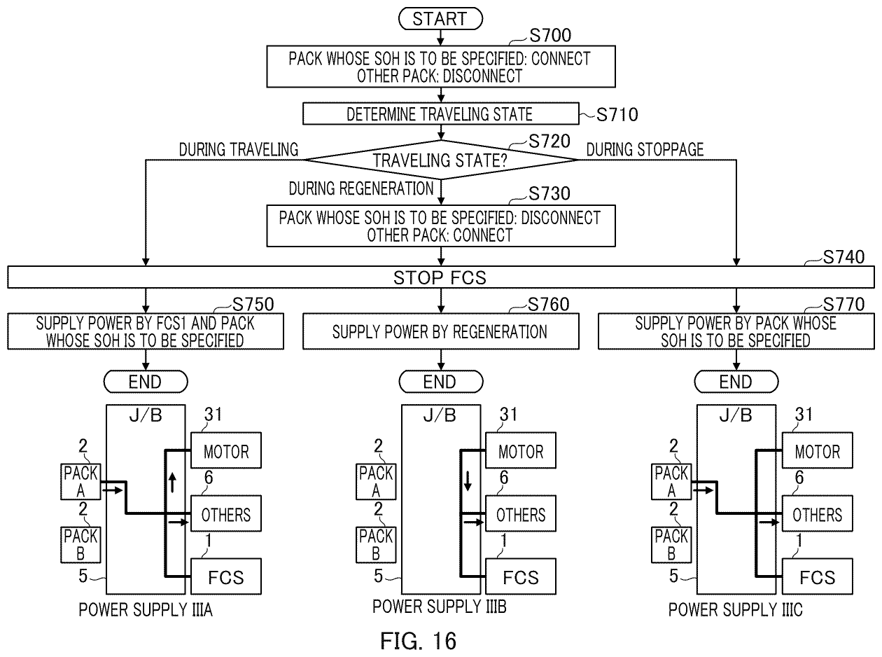

Next, in step S190, control section 100 executes the control of discharging pack A whose SOH is to be specified (control III). In control III, the SOC calculation information of pack A is transmitted from BMS 22. Details of control III will be described below with reference to FIG. 16 as the operation of control III (during discharging) of the control system (VCU).

Next, in step S200, control section 100 checks the SOC calculation information of pack A whose SOH is to be specified.

In step S210, control section 100 determines whether or not the SOC of pack A is less than 20%. When the SOC of pack A is less than 20% (step S210: yes), the processing transitions to step S220. When the SOC of pack A is not less than 20% (step S210: no), the processing returns to before step S190.

In step S220, control section 100 executes the control of using only the other pack 2 (discharging only pack B) (control II).

In step S230, after one hour from the determination that the SOC of pack A is less than 20%, control section 100 performs the following control with respect to BMS 22: storing the measurement results of the open circuit voltage (OCV) and the temperature of pack A whose SOH is to be specified in the storage section (not illustrated) in BMS 22.

In step S240, control section 100 executes the control of calculating the accurate SOC of pack A from the OCVs at 80% SOC and 20% SOC of pack A and the temperatures of pack A at 80% SOC and 20% SOC. In addition, control section 100 executes the control of specifying the SOH from a predetermined expression based on the calculated SOC and the initial SOC.

Next, in step S250, control section 100 executes the control of charging pack A whose SOH is to be specified (control I).

Next, in step S260, control section 100 checks the SOC calculation information of all the packs 2.

Next, in step S270, control section 100 determines whether or not the SOCs of all the packs 2 are the same (the SOC of pack A and the SOC of pack B are the same). When the SOCs are not the same (step S270: no), the processing returns to before step S250. When the SOCs are the same (step S270: yes), the processing transitions to step S280.

In step S280, control section 100 controls the charge and discharge between the three parts, namely fuel cell system 1, plurality of packs 2, and electric PF system 3 so that the vehicle travels normally (return to normal traveling).

### <Control I (During Charging) Operation of Control System (VCU)>

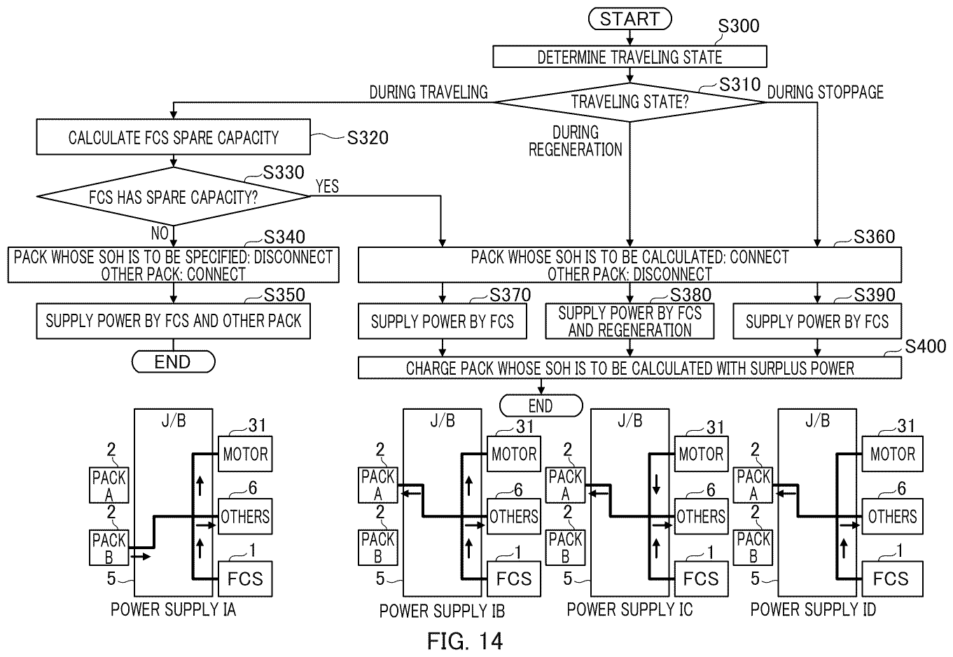

Next, an example of the operation of control I (during charging) of control system 4 (VCU) according to the present embodiment will be described with reference to FIG. 14. FIG. 14 is a flowchart illustrating an example of the operation of control I (during charging) of the control system (VCU) according to the present embodiment. Here, for convenience, pack 2 whose SOH is to be specified is referred to as pack A, and the other pack is referred to as pack B. In addition, FIG. 14 illustrates the modes of the power supply as power supply IA, power supply IB, power supply IC, and power supply ID, and arrows indicating the directions of power supply. In addition, in FIG. 14, junction box 5 is indicated by “J/B”, other components 6 are indicated by “others”, and the regeneration operation of motor 31 is indicated by “regeneration”.

In step S300, control section 100 determines the traveling state of the vehicle.

In step S310, when the traveling state of the vehicle is traveling (step S310: during traveling), the processing transitions to step S320. When the traveling state of the vehicle is regeneration (step S310: during regeneration), the processing transitions to step S360. When the traveling state of the vehicle is such that the vehicle is stopped (step S310: during stoppage), the processing transitions to step S360.

In step S320, control section 100 (calculation section 130) calculates the spare capacity of FCS 1 based on the requested output information of motor 31 and the available power information of FCS 1.

In step S330, control section 100 determines whether or not FCS 1 has the spare capacity. When FCS 1 has the spare capacity (step S330: yes), the processing transitions to step S360. When FCS 1 does not have the spare capacity (step S330: no), the processing transitions to step S340.

In step S340, control section 100 executes the control of electrically disconnecting pack 2 (pack A) whose SOH is to be specified and electrically connecting the other pack 2 (pack B).

In step S350, control section 100 executes the control of supplying the power to motor 31 and other components 6 by FCS 1 and the other pack 2 (pack B) (power supply IA). Thereafter, the present flow ends.

In step S360, control section 100 executes the control of electrically connecting pack 2 (pack A) whose SOH is to be specified and electrically disconnecting the other pack 2 (pack B).

Next, in step S370, control section 100 executes the control of supplying the power to pack A, motor 31, and other components 6 by FCS 1 (power supply IB). Thereafter, the processing transitions to step S400.

In step S380, control section 100 executes the control of supplying the power to pack A and other components 6 by FCS 1 and the regeneration (power supply IC). Thereafter, the processing transitions to step S400.

In step S390, control section 100 executes the control of supplying the power to pack A and other components 6 by FCS 1 (power supply ID). Thereafter, the processing transitions to step S400.

In step S400, control section 100 executes the control of charging pack 2 (pack A) whose SOH is to be specified with the surplus power. Thereafter, the present flow ends.

### <Control II (During Measuring of OCV) Operation of Control System (VCU)>

Next, an example of the operation of control II (during measuring of OCV) of control system 4 (VCU) according to the present embodiment will be described with reference to FIG. 15. FIG. 15 is a flowchart illustrating an example of the operation of control II (during measuring of OCV) of the control system (VCU). Here, for convenience, pack 2 whose SOH is to be specified is referred to as pack A, and the other pack is referred to as pack B. In addition, FIG. 15 illustrates the modes of the power supply as power supply IIA, power supply IIB, power supply IIC, power supply IID, and power supply IIE, and arrows indicating the directions of power supply. In addition, in FIG. 15, junction box 5 is indicated by “J/B”, other components 6 are indicated by “others”, and the regeneration operation of motor 31 is indicated by “regeneration”.

In step S500, control section 100 executes the control of electrically disconnecting pack 2 (pack A) whose SOH is to be specified and electrically connecting the other pack 2 (pack B).

In step S510, control section 100 determines the traveling state of the vehicle.

In step S520, when the traveling state of the vehicle is traveling (step S520: during traveling), the processing transitions to step S530. When the traveling state of the vehicle is regeneration (step S520: during regeneration), the processing transitions to step S580. When the traveling state of the vehicle is such that the vehicle is stopped (step S520: during stoppage), the processing transitions to step S600.

In step S530, control section 100 (calculation section 130) calculates the spare capacity of FCS 1 based on the requested output information of motor 31 and the available power information of FCS 1.

In step S540, control section 100 determines whether or not FCS 1 has the spare capacity. When FCS 1 has the spare capacity (step S540: yes), the processing transitions to step S560. When FCS 1 does not have the spare capacity (step S540: no), the processing transitions to step S550.

In step S550, control section 100 executes the control of supplying the power to motor 31 and other components 6 by FCS 1 and the other pack 2 (pack B) (power supply IIA). Thereafter, the present flow ends.

In step S560, control section 100 executes the control of supplying the power to pack B, motor 31, and other components 6 by FCS 1 (power supply IIB).

Next, in step S570, control section 100 executes the control of charging the other pack 2 (pack B) with the surplus power. Thereafter, the present flow ends.

In step S580, control section 100 executes the control of stopping the power supply by FCS 1.

Next, in step S590, control section 100 executes the control of supplying the power to pack B and other components 6 by the regeneration (power supply IIC). Thereafter, the processing transitions to step S570.

In step S600, control section 100 checks the spare capacity of the SOC of the other pack 2 (pack B).

In step S610, whether or not pack B has the spare capacity of the SOC is determined. When pack B has the spare capacity of the SOC (step S610: yes), the processing transitions to step S630. When pack B does not have the spare capacity of the SOC (step S610: no), the processing transitions to step S620.

In step S620, control section 100 executes the control of supplying the power to pack B and other components 6 by FCS 1 (power supply IID). Thereafter, the processing transitions to step S570.

In step S630, control section 100 executes the control of supplying the power to motor 31 and other components 6 by FCS 1 and the other pack 2 (pack B) (power supply IIE). Thereafter, the present flow ends.

### <Control III (During Discharging) Operation of Control System (VCU)>

Next, an example of the operation of control III (during discharging) of control system 4 (VCU) according to the present embodiment will be described with reference to FIG. 16. FIG. 16 is a flowchart illustrating an example of the operation of control III (during discharging) of the control system (VCU) according to the present embodiment. Here, for convenience, pack 2 whose SOH is to be specified is referred to as pack A, and the other pack is referred to as pack B. In addition, FIG. 16 illustrates the modes of the power supply as power supply IIIA, power supply IIIB, and power supply IIIC, and arrows indicating the directions of power supply. In addition, FIG. 16, junction box 5 is indicated by “J/B”, other components 6 are indicated by “others”, and the regeneration operation of motor 31 is indicated by “regeneration”.

In step S700, control section 100 executes the control of electrically connecting pack 2 (pack A) whose SOH is to be specified and electrically disconnecting the other pack 2 (pack B).

Next, in step S710, control section 100 determines the traveling state of the vehicle.

Next, in step S720, when the traveling state of the vehicle is traveling (step S710: during traveling), the processing transitions to step S750 via step S740. When the traveling state of the vehicle is regeneration (step S710: during regeneration), the processing transitions to step S730. When the traveling state of the vehicle is such that the vehicle is stopped (step S710: during stoppage), the processing transitions to step S770 via step S740.

Next, in step S730, the control of electrically disconnecting pack 2 (pack A) whose SOH is to be specified and electrically disconnecting the other pack 2 (pack B) is executed. Thereafter, the processing transitions to step S760 via step S740.

Next, in step S740, control section 100 executes the control of stopping the power supply by FCS 1.

Next, in step S750, control section 100 executes the control of supplying the power to motor 31 and other components 6 by FCS 1 and pack 2 (pack A) whose SOH is to be specified (power supply IIIA). Thereafter, the present flow ends.

Next, in step S760, control section 100 executes the control of supplying the power to other components 6 by the regeneration (power supply IIIB). Thereafter, the present flow ends.

Next, in step S770, control section 100 executes the control of supplying the power to other components 6 by pack 2 (pack A) whose SOH is to be specified (power supply IIIC). Thereafter, the present flow ends.

### <Normal Control Operation of Control System (VCU)>

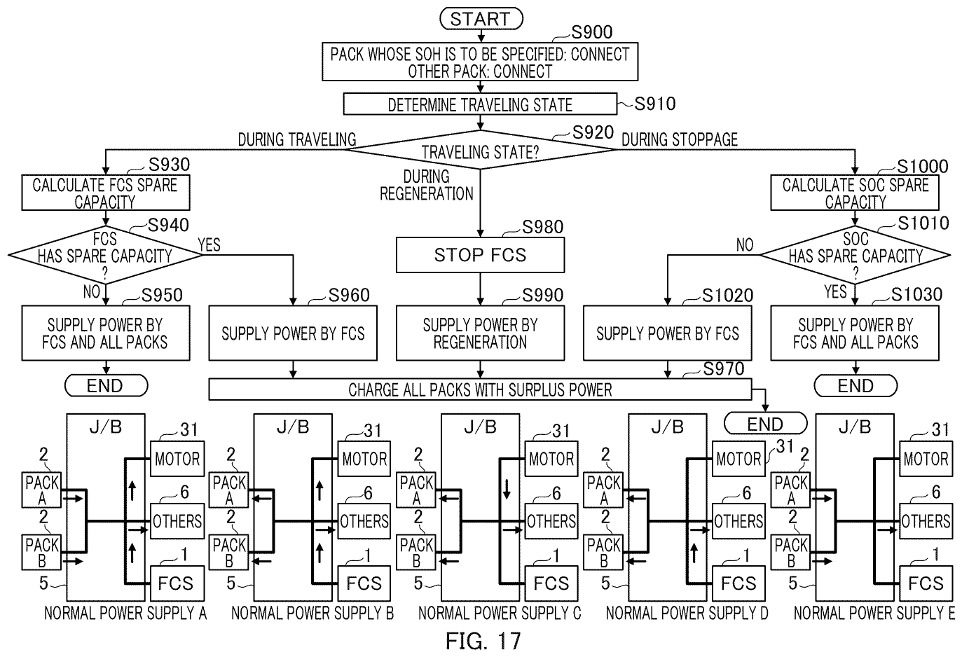

Next, an example of the operation during normal control of control system 4 (VCU) according to the present embodiment will be described with reference to FIG. 17. FIG. 17 is a flowchart illustrating an example of the operation during normal control of the control system (VCU) according to the present embodiment. Here, for convenience, pack 2 whose SOH is to be specified is referred to as pack A, and the other pack is referred to as pack B. In addition, FIG. 17 illustrates the modes of the power supply as normal power supply A, normal power supply B, normal power supply C, normal power supply D, and normal power supply E, and arrows indicating the directions of power supply. In addition, in FIG. 17, junction box 5 is indicated by “J/B”, other components 6 are indicated by “others”, and the regeneration operation of motor 31 is indicated by “regeneration”.

In step S900, control section 100 executes the control of electrically connecting pack 2 (pack A) whose SOH is to be specified and electrically connecting the other pack 2 (pack B).

Next, in step S910, control section 100 determines the traveling state of the vehicle.

Next, in step S920, when the traveling state of the vehicle is traveling (step S920: during traveling), the processing transitions to step S930. When the traveling state of the vehicle is regeneration (step S920: during regeneration), the processing transitions to step S920. When the traveling state of the vehicle is such that the vehicle is stopped (step S920: during stoppage), the processing transitions to step S1000.

Next, in step S930, control section 100 (calculation section 130) calculates the spare capacity of FCS 1 based on the requested output information of motor 31 and the available power information of FCS 1.

Next, in step S940, control section 100 determines whether or not FCS 1 has the spare capacity. When FCS 1 has the spare capacity (step S940: yes), the processing transitions to step S960. When FCS 1 does not have the spare capacity (step S940: no), the processing transitions to step S950.

Next, in step S950, control section 100 executes the control of supplying the power to motor 31 and other components 6 by FCS 1 and all the packs 2 (pack A and pack B) (normal power supply A). Thereafter, the present flow ends.

Next, in step S960, control section 100 executes the control of supplying the power to packs A and B, motor 31, and other components 6 by FCS 1 (normal power supply B).

Next, in step S970, control section 100 executes the control of charging all the packs 2 (pack A and pack B) with the surplus power. Thereafter, the present flow ends.

Next, in step S980, control section 100 executes the control of stopping the power supply by FCS 1.

Next, in step S990, control section 100 executes the control of supplying the power to packs A and B and other components 6 by the regeneration (normal power supply C). Thereafter, the processing transitions to step S970.

Next, in step S1000, control section 100 checks the spare capacity of the SOC of packs A and B.

Next, in step S1010, whether or not packs A and B have the spare capacity of the SOC is determined. When packs A and B have the spare capacity of the SOC (step S1010: yes), the processing transitions to step S1030. When packs A and B do not have the spare capacity of the SOC (step S1010: no), the processing transitions to step S1020.

Next, in step S1020, control section 100 executes the control of supplying the power to packs A and B and other components 6 by FCS 1 (normal power supply D). Thereafter, the processing transitions to step S970.

Next, in step S1030, control section 100 executes the control of supplying the power to other components 6 by FCS 1 and packs A and B (normal power supply E). Thereafter, the present flow ends.

Control system 4 according to the embodiment is an in-vehicle control apparatus including the following: fuel cell system 1 that generates power using hydrogen; plurality of packs 2 (or modules 21); and motor 31 that operates by power of fuel cell system 1 and plurality of packs 2. The control system includes control section 100 that controls, when specifying an SOH of at least one target pack 2 among the plurality of packs 2 is performed during traveling of the vehicle, charge and discharge between the three parts—namely fuel cell system 1, pack 2, and motor 31—by one of a plurality of control modes including a first control mode and a second control mode. The first control mode is a mode in which power is supplied from fuel cell system 1 to motor 31 and the plurality of packs 2, and the second control mode is a mode in which power is supplied from fuel cell system 1 to motor 31 and the least one target pack 2 and power is not supplied from fuel cell system 1 to pack 2 (among the plurality of packs 2) other than the least one target pack 2.

With the above-described configuration, since the charging of pack 2 that is the target (herein also referred to as “target pack 2”) can be promoted during traveling of the vehicle, the SOC of the target pack 2 during traveling of the vehicle can be increased to the predetermined amount or more at a relatively early stage.

In addition, in control system 4 according to the embodiment, control section 100 controls the charge and discharge between the three parts, namely fuel cell system 1, pack 2, and motor 31 as follows: when a predetermined period has elapsed after the specifying of the SOH of the target pack 2 (or module 21), control section 100 controls the charge and discharge by the second control mode, and when a predetermined period has not elapsed after the specifying of the SOH of the target pack 2, control section 100 controls the charge and discharge by the first control mode. As a result, control section 100 selects either one of the control modes according to whether or not the predetermined period has elapsed from the specification of the target pack 2. Therefore, plurality of packs 2 can be used evenly to eliminate the unbalance except for the period for specifying the SOH of the target pack 2, while the charging amount of the target pack 2 can be reduced to less than the predetermined amount or more at a relatively early stage in the period for specifying SOH.

In addition, in control system 4 according to the embodiment, the plurality of control modes include a third control mode and a fourth control mode. The third control mode is a mode in which power is supplied from fuel cell system 1 and plurality of packs 2 (or modules 21) to motor 31, and the fourth control mode is a mode in which power is supplied from fuel cell system 1 and pack 2 (other than the target pack 2) among plurality of packs 2 to motor 31, and power is not supplied from the target pack 2 to motor 31. Control section 100 controls the charge and discharge between the three parts, namely fuel cell system 1, pack 2, and motor 31, by either the third control mode or the fourth control mode when the power that can be output by fuel cell system 1 (i.e., power available from fuel cell system 1) is small with respect to the requested output of motor 31. As a result, during traveling, the third control mode is selected when the output of the FCS is sufficient with respect to the requested output of the motor, and the fourth control mode is selected when the output of the FCS is insufficient with respect to the requested output of the motor during traveling and the output from the battery is required. Therefore, it is possible to suppress discharge from the target pack 2, and prevention of the charging of the target pack 2 is less likely to occur.

In addition, in control system 4 according to the embodiment, control section 100 controls the charge and discharge between the three parts, namely fuel cell system 1, pack 2, and motor 31 as follows: when a predetermined period has elapsed from the specification of the SOH of pack 2 (or module 21) that is a target, control section 100 controls the charge and discharge by the second control mode, and when a predetermined period has not elapsed after the specifying of the SOH of the target pack 2, control section 100 controls the charge and discharge by the first control mode. As a result, since plurality of packs 2 are used evenly except for the period for specifying the SOH of the target pack 2, the unbalance of the SOH between the packs 2 can be eliminated. On the other hand, since the target pack 2 is used with priority during the period for specifying SOH, the charging amount of the target pack 2 can be increased to the predetermined amount or more at a relatively early stage.

In addition, in control system 4 according to the embodiment, the plurality of control modes include a fifth control mode in which the regenerative power generated by motor 31 is supplied to each pack 2 (or each module 21), and a sixth control mode in which the regenerative power is supplied to target pack 2 and is not supplied to pack 2 other than the target pack 2. Control section 100 controls the charge and discharge between the three parts, namely fuel cell system 1, pack 2, and motor 31 as follows: when a predetermined period has elapsed after the specifying of the SOH of the target pack 2, control section 100 controls the charge and discharge by the sixth control mode, and when a predetermined period has not elapsed after the specifying of the SOH of the target pack 2, control section 100 controls the charge and discharge by the fifth control mode. As a result, since the regenerative power generated by motor 31 is supplied to the target pack 2 with priority, the charging of the target pack 2 during the regeneration operation of motor 31 can be promoted.

In addition, in control system 4 according to the embodiment, the SOH of pack 2 (or module 21) that is the target is specified based on a first output voltage and a first temperature of the target pack 2 in a case of the remaining capacity (SOC) of the target pack 2 exceeding the first threshold value. As a result, for specifying the SOH, the remaining capacity (SOC) of the target battery measured under the suitable conditions can be used.

In addition, in control system 4 according to the embodiment, the plurality of control modes include a seventh control mode in which power is supplied from pack 2 (or module 21) that is the target to motor 31, and power is not supplied from pack 2 (other than the target pack 2) or fuel cell system 1 to motor 31. Control section 100 controls the charge and discharge between the three parts, namely fuel cell system 1, pack 2, and motor 31, by the seventh control mode after the SOH of the target pack 2 is specified. As a result, since the discharge of the target pack 2 can be promoted during traveling of the vehicle, the charging amount of the target pack 2 can be reduced to less than the predetermined amount relatively quickly.

In addition, in control system 4 according to the embodiment, the SOH of pack 2 (or module 21) that is the target is specified based on a second output voltage of the target pack 2 in a case of the remaining capacity (SOC) of the target pack 2 being less than the second threshold value and a second temperature of the target pack 2. As a result, the remaining capacity (SOC) of the target pack 2 measured under the suitable conditions can be used for specifying the SOH.

In addition, in control system 4 according to the embodiment, the SOH of pack 2 (or module 21) that is the target is specified based on an integrated amount of the current output from the target pack 2 after the remaining capacity (SOC) of the target pack 2 exceeds the first threshold value until the remaining capacity (SOC) of the target pack 2 is reduced to less than the second threshold value. As a result, since the SOH of the target pack 2 is specified based on the remaining capacity (SOC) of the target pack 2 measured under the suitable conditions, the measurement accuracy of the SOH can be increased.

In addition, in control system 4 according to the embodiment, the first threshold value is 80%, and the second threshold value is 20%. As a result, since the change amount of the remaining capacity (SOC) of the target pack 2 (or module 21) can be increased to the predetermined amount or more, the measurement accuracy of the SOH can be increased.

In addition, control system 4 according to the embodiment further includes the following: acquisition section 120 that acquires requested output information related to the requested output of motor 31 and available power information related to the power that can be output by fuel cell system 1; and calculation section 130 that calculates the spare capacity of fuel cell system 1 based on the acquired requested output information and available power information. Control section 100 controls the charge and discharge between the three parts, namely fuel cell system 1, pack 2 (or module 21), and motor 31, by either the first control mode or the second control mode based on a magnitude of the spare capacity of fuel cell system 1 calculated by calculation section 130. As a result, even when the spare capacity of fuel cell system 1 is relatively small, control section 100 selecting the second control mode allows the power to be supplied from fuel cell system 1 to the target pack 2, and thus the SOC of the target pack 2 can be increased to the predetermined amount or more at a relatively early stage.

Control system 4 according to the embodiment has been described as follows: control section 100 that controls, when specifying an SOH of at least one target pack 2 among the plurality of packs 2 is performed during traveling of the vehicle, the charge and discharge between the three parts (namely fuel cell system 1, pack 2, and motor 31) by one of a plurality of control modes including a first control mode and a second control mode (the first control mode is a mode in which power is supplied from fuel cell system 1 to motor 31 and the plurality of packs 2, and a second control mode is a mode in which power is supplied from fuel cell system 1 to motor 31 and the least one target pack 2 and power is not supplied from fuel cell system 1 to pack 2 among the plurality of packs 2 other than the least one target pack 2). However, the present disclosure is not limited thereto. Control section 100 that controls the charge and discharge among the above three parts may be used when the SOHs of two or more packs 2 (that are targets) among plurality of packs 2 are specified during traveling of the vehicle. Even in this case, the two or more target packs 2 are controlled in the same manner as the one target pack 2 in the above-described embodiment, and pack 2 other than the two or more target packs 2 is controlled in the same manner as pack 2 other than the one target pack 2 in the above-described embodiment.

In addition, the above-described embodiments are merely examples of specific embodiments for carrying out the present disclosure, and the technical scope of the present disclosure should not be construed as being limited thereto. That is, the present disclosure can be carried out in various forms without departing from the gist or the main features thereof.

### INDUSTRIAL APPLICABILITY

The present disclosure is suitably used in a fuel cell electric vehicle including a control apparatus that is required to increase the change amount of the SOC of the battery to a predetermined amount or more at a relatively early stage during traveling of the vehicle.

The invention claimed is:

1. A control apparatus in a vehicle including a fuel cell system that generates power using hydrogen, a plurality of power storage apparatuses and a motor that operates by power of the fuel cell system and the plurality of power storage apparatuses, the control apparatus comprising a processor:
the processor, wherein
when specifying an SOH of at least one target power storage apparatus among the plurality of power storage apparatuses is performed during traveling of the vehicle,
the processor controls charge and discharge between the fuel cell system, the plurality of power storage apparatuses, and the motor by one of a plurality of control modes including a first control mode and a second control mode, the first control mode being a mode in which power is supplied from the fuel cell system to the motor and the plurality of power storage apparatuses, the second control mode being a mode in which power is supplied from the fuel cell system to the motor and the at least one target power storage apparatus and is not supplied from the fuel cell system to a power storage apparatus that is other than the at least one target power storage apparatus among the plurality of power storage apparatuses.

2. The control apparatus according to claim 1, wherein
the processor controls the charge and discharge between the fuel cell system, the plurality of power storage apparatuses, and the motor by the second control mode when a predetermined period has elapsed after the specifying of the SOH of the at least one target power storage apparatus and by the first control mode when the predetermined period has not elapsed after the specifying of the SOH of the at least one target power storage apparatus.

3. The control apparatus according to claim 1, wherein:
the plurality of control modes include a third control mode and a fourth control mode, the third control mode being a mode in which power is supplied from the fuel cell system and the plurality of power storage apparatuses to the motor, the fourth control mode being a mode in which power is supplied from the fuel cell system and the power storage apparatus other than the at least one target power storage apparatus among the plurality of power storage apparatuses to the motor and is not supplied from the at least one target power storage apparatus to the motor; and
when power available from the fuel cell system is smaller than a requested output of the motor, the processor controls the charge and discharge between the fuel cell system, the plurality of power storage apparatuses, and the motor by either one of the third control mode and the fourth control mode.

4. The control apparatus according to claim 3, wherein
the processor controls the charge and discharge between the fuel cell system, the plurality of power storage apparatuses, and the motor by the second control mode when a predetermined period has elapsed after the specifying of the SOH of the at least one target power storage apparatus and by the first control mode when the predetermined period has not elapsed after the specifying of the SOH of the at least one target power storage apparatus.

5. The control apparatus according to claim 2, wherein:
the plurality of control modes include a fifth control mode and a sixth control mode, the fifth control mode being a mode in which regenerative power generated by the motor is supplied to each of the plurality of power storage apparatuses, the sixth control mode being a mode in which the regenerative power is supplied to the at least one target power storage apparatus and is not supplied to the power storage apparatus other than the at least one target power storage apparatus; and
the processor controls the charge and discharge between the fuel cell system, the plurality of power storage apparatuses, and the motor by the sixth control mode when the predetermined period has elapsed after the specifying of the SOH of the at least one target power storage apparatus and by the fifth control mode when the predetermined period has not elapsed after the specifying of the SOH of the at least one target power storage apparatus.

6. The control apparatus according to claim 2, wherein
the SOH of the at least one target power storage apparatus is specified based on a first output voltage and a first temperature of the at least one target power storage apparatus in a case of remaining capacity of the at least one target power storage apparatus exceeding a first threshold value.

7. The control apparatus according to claim 6, wherein:
the plurality of control modes include a seventh control mode in which power is supplied from the at least one target power storage apparatus to the motor and is not supplied from the fuel cell system or the power storage apparatus other than the at least one target power storage apparatus to the motor; and
the processor controls the charge and discharge between the fuel cell system, the plurality of power storage apparatuses, and the motor by the seventh control mode after the specifying of the SOH of the at least one target power storage apparatus.

8. The control apparatus according to claim 7, wherein
the SOH of the at least one target power storage apparatus is specified based on a second output voltage and a second temperature of the at least one target power storage apparatus in a case of the remaining capacity of the at least one target power storage apparatus being less than a second threshold value.

9. The control apparatus according to claim 8, wherein
the SOH of the at least one target power storage apparatus is specified based on an integrated amount of a current output from the at least one target power storage apparatus after the remaining capacity of the at least one target power storage apparatus exceeds the first threshold value until the remaining capacity of the at least one target power storage apparatus is reduced to less than the second threshold value.

10. The control apparatus according to claim 8, wherein
the first threshold value is 80%, and the second threshold value is 20%.

11. The control apparatus according to claim 1, wherein
the processor acquires requested output information related to a requested output of the motor and available power information related to power available from the fuel cell system,
the processor calculates spare capacity of the fuel cell system based on the acquired requested output information and available power information, and
the processor controls the charge and discharge between the fuel cell system, the plurality of power storage apparatuses, and the motor by either one of the first control mode and the second control mode based on a magnitude of the calculated spare capacity of the fuel cell system.
